(19) United States
(12) Patent Application Publication
(10) Pub. No.: US 2008/0085371 A1
(43) Pub. Date: Apr. 10, 2008

(54) FIXTURING METHODS AND APPARATUS FOR THERMAL SPRAY SYSTEMS AND PROCESSES

(75) Inventors: Sauri Gudlavalleti, Santa Clara, CA (US); Larry Steven Rosenzweig, Clifton Park, NY (US); Shu Ching Quek, Clifton Park, NY (US); Chandra Sekher Yerramalli, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/538,880

(22) Filed: Oct. 5, 2006

(51) Int. Cl. B05D 3/00; B05D 1/08

(52) U.S. Cl. 427/446; 118/300

(57) ABSTRACT

A thermal spray system is provided. The thermal spray system includes a spray assembly for applying a coating to a workpiece. The thermal spray system also includes a fixturing assembly couplable to the workpiece for positioning the workpiece relative to the thermal spray system, wherein the fixturing assembly permits the workpiece to distort during application of the coating to minimize residual strain buildup within the workpiece and reduce coating stresses.

### BACKGROUND

The invention relates generally to fixturing methods, and more specifically to fixturing methods and apparatus for thermal spray processes.

Conventional thermal spray processing typically involves mechanically constraining or clamping a workpiece to a backing plate or other surface or device. Once the workpiece is constrained and positioned, a thermal spray gun is translated along one or more axes of the workpiece and coats the workpiece with a high temperature thermal spray.

Workpieces that are coated by these thermal spray processes often warp due to residual stresses caused by large thermal gradients within the workpieces. The residual stress occurs because of the imposed mechanical constraints applied upon the workpiece that prevent free expansion or contraction of the part during the thermal spray process. When the region directly under a spray gun heats up excessively it will naturally expand. When the heated portions of the workpiece begin to expand naturally in response to the heat, the mechanical constraints limit this and when stresses exceed material yield strength, residual stresses are accumulated upon cool down. Upon releasing it from the backing plate or other surface, the built up residual stress within the workpiece causes the structure to distort by bending, curling or otherwise warping. Such distortions are highly undesirable. Such distortions are especially aggravated in thinner lightweight components. In addition to causing warpage, the residual stress translates into high residual stresses in the coating applied upon the substrate. Developing spray techniques with minimal warpage and reduced stresses on coating of the workpiece is critical in many applications.

To alleviate effects of the warpage as discussed above, certain conventional techniques apply thermal management to the thermal spray system to minimize the temperature gradients in the workpiece during the spray process. Accordingly, the expansion of the particular region under the plasma gun is limited to that due to the smaller temperature gradient. Even in an ideally isothermal state, however, workpieces will warp if the mechanical constraints cause thermally induced stresses to exceed material yield stress or plastic limit. In terms of coating stresses, being held in an isothermal state will not adequately alleviate the high residual stresses developed upon cool down. Typically, if a coating with coefficient of thermal expansion (CTE) different than the substrate is deposited on a mechanically constrained substrate (i.e. the substrate is heated to the operating temperature of deposition under constraints) it generally develops tensile stresses on cooldown.

Accordingly, there is a need for a new thermal spray process, and associated apparatus to allow efficient thermal spray applications, while limiting the warpage of the underlying workpiece.

### BRIEF DESCRIPTION

In accordance with an embodiment of the invention, a thermal spray system is provided. The thermal spray system includes a spray assembly for applying a coating to a workpiece. The thermal spray system also includes a fixturing assembly couplable to the workpiece for positioning the workpiece relative to the thermal spray system. The fixturing assembly permits the workpiece to distort during application of the coating to minimize residual strain buildup within the workpiece and also minimize coating stresses upon cool down of the workpiece.

In accordance with another embodiment of the invention, a thermal spray apparatus is provided. The thermal spray apparatus includes a fixturing device configured to physically hold the part over the entire non-sprayed surface while permitting the sprayed and unsprayed part to flex during application of a thermal spray.

In accordance with another embodiment of the invention, a method of thermal spraying including fixturing a workpiece is provided. The method also includes applying a thermal spray to the workpiece. The method also includes allowing the workpiece to expand or contract due to the application of the thermal spray with minimal interference from said fixturing. The method further includes cooling the workpiece down to room temperature to allow the workpiece to recover from during spray expansion or contraction.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic illustration of a typical workpiece under a thermal spray system;

FIG. 2 is a diagrammatic illustration of the workpiece in FIG. 1 under mechanical constraints;

FIG. 3 is a diagrammatic illustration of a thermal spray system forming a coating on the workpiece in FIG. 1;

FIG. 4 is a diagrammatic illustration of warping in a workpiece after process of thermal spraying is completed;

FIG. 5 is a diagrammatic illustration of a fixturing assembly including a clamp for the workpiece in FIG. 1 in accordance with an embodiment of the invention;

FIG. 6 is a diagrammatic illustration of a fixturing assembly including a bed of springs for the workpiece in FIG. 1 in accordance with an embodiment of the invention;

FIG. 7 is a diagrammatic illustration of a fixturing assembly including multiple tethers for the workpiece in FIG. 1 in accordance with an embodiment of the invention;

FIG. 8 is a diagrammatic illustration of a fixturing assembly including a thermally resistant cushion for the workpiece in FIG. 1 in accordance with an embodiment of the invention;

FIG. 9 is a flow chart representing exemplary steps in a method of thermal spraying the workpiece in FIG. 1 in accordance with an embodiment of the invention;

FIG. 10 is a diagrammatic illustration of an experimental set up of a supported strip of stainless steel used in an electrolyzer electrode;

FIG. 11 is a tabular representation of the results of measurements made for detection of warpage on the strip of stainless steel in FIG. 10;

FIG. 12 is a graphical comparison of coating stresses on a constrained sample and an unconstrained sample as a function of ratio of thickness of a coating to thickness of a substrate;

FIG. 13 is a magnified view of a coating stress curve of an unconstrained sample in FIG. 12 as a function of ratio of thickness of a coating to thickness of a substrate;

FIG. 14 is a graphical comparison of coating stresses on a constrained sample and an unconstrained sample as a function of ratio of coating modulus to substrate modulus;

FIG. 15 is a magnified view of a coating stress curve of an unconstrained sample in FIG. 14 as a function of ratio of coating modulus to substrate modulus;

FIG. 16 is a graphical comparison of coating stresses on a constrained sample and an unconstrained sample as a function of difference in coefficient of thermal expansion between substrate and coating; and

FIG. 17 is a magnified view of a coating stress curve of an unconstrained sample in FIG. 16 as a function of difference in coefficient of thermal expansion between substrate and coating.

### DETAILED DESCRIPTION

As discussed in detail below, embodiments of the present invention include a fixturing assembly for thermal spray systems and processes and a method for the same. Thermal spraying is a commonly used engineering coating process that offers a wide choice of materials and techniques. During thermal spraying, particles of about 1 to about 90 microns are partially or fully melted and accelerated to high velocities by various techniques. These particles then strike a substrate or a workpiece wherein they get deformed and are bonded onto the workpiece. A coating is formed as the particles are deposited on top of each other. Some non-limiting examples of ‘thermal spray systems’ used herein may include a thermal spray system involving a DC plasma spray, wire-arc spray, flame spray, or high-velocity oxygen fuel thermal spray process (HVOF).

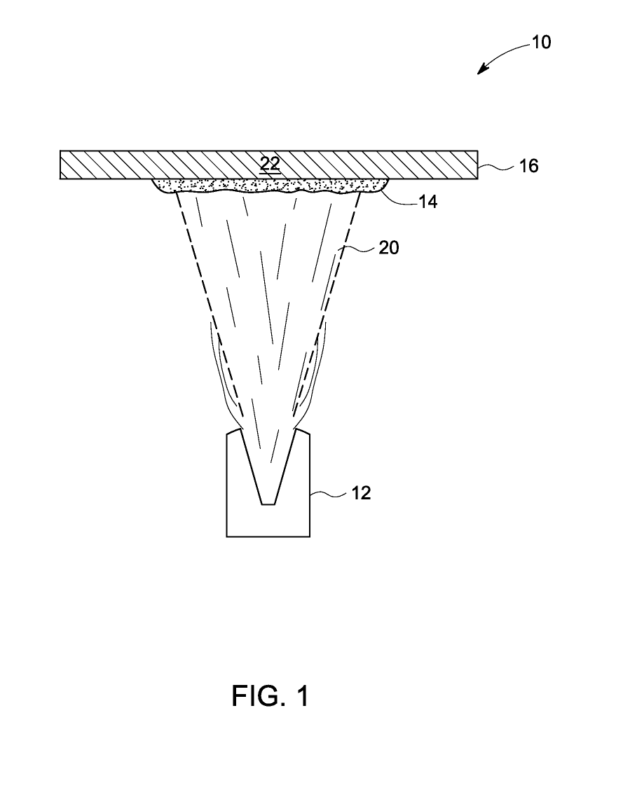

In an illustrated embodiment of the invention as shown in FIG. 1, a thermal spray system 10 is depicted. The thermal spray system 10 includes a spray assembly or a spray gun 12 for applying a coating 14 to a workpiece 16. Components such as the workpiece 16 when coated by the thermal spray system 10 commonly tend to warp due to residual stresses caused by thermal gradients within the workpiece 16. Residual stresses generally occur due to imposed mechanical constraints that prevent natural tendency of free expansion or contraction of the workpiece 16 during a thermal spray 20. Some non-limiting examples of the workpiece 16 may include a fuel cell component, an electrolyzer component, and a gas turbine hot gas path component. In another embodiment, the workpiece 16 may be a solid oxide fuel cell component. In a particular embodiment, operating temperature of the thermal spray 20 may be in the range between about 1000° C. to about 7000° C. When the thermal spray 20 that includes highly accelerated particles strikes a portion 22 of the workpiece 16, the portion 22 gets heated excessively resulting in a natural tendency of thermal expansion. Commonly found constraints that prevent free expansion or contraction of the portion 22 are externally applied mechanical constraints such as clamps and backing plates and thermal gradients between the portion 22 and surrounding portions and through thickness on the underside of portion 22. The portion 22 may also tend to expand or contract due to transformation of its material state. Some non-limiting examples of transformation in material state may include melting, resolidification and recrystallization.

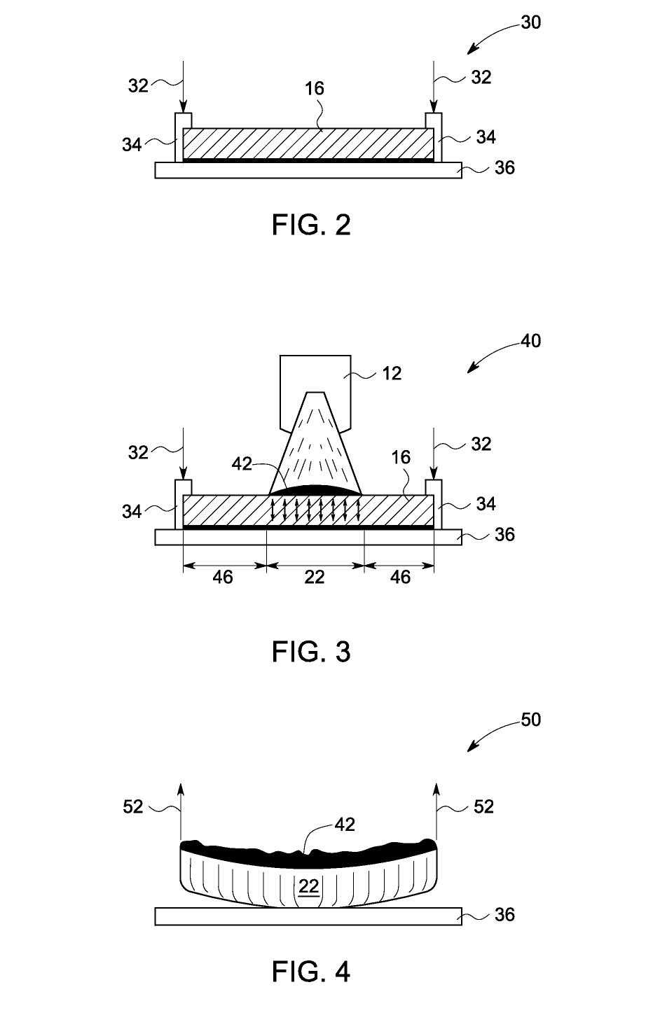

FIG. 2 is a diagrammatical illustration of a system 30 including a workpiece 16 as referenced in FIG. 1 that may be physically constrained by mechanical constraints 34. The mechanical constraints 34 exert a force in a direction 32 on the workpiece 16. In a particular embodiment, the workpiece 16 may include strips of stainless steel. Some non-limiting examples of mechanical constraints include clamps and backing plates. The workpiece 16 may be attached to a base 36.

FIG. 3 is a diagrammatical illustration of a workpiece system 40 undergoing heating by a thermal spray assembly 12 as referenced in FIG. 1. The workpiece system 40 includes the workpiece 16 as referenced in FIG. 1 that may be physically constrained by mechanical constraints 34 as referenced in FIG. 2. The workpiece 16 may also be attached to a base 36 as referenced in FIG. 2. The thermal assembly 12 forms a coating 42 on the workpiece 16 as referenced in FIG. 1. In a particular embodiment, the workpiece 16 may include strips of stainless steel. A portion or hot spot 22 as referenced in FIG. 1 that is directly under the spray assembly 12 heats up excessively leading to expansion of the portion 22. As the portion 22 tends to expand, the mechanical constraints 34 as referenced in FIG. 2 prevent the expansion. In addition, thermal gradients across thickness of the workpiece 16 may constrain expansion of the portion 22.

FIG. 4 is a diagrammatical illustration of a workpiece system 50 without a mechanical constraint after a process of thermal spraying is completed. The portion 22 as referenced in FIG. 1 of the workpiece 16 as referenced in FIG. 1 being directly under the spray assembly 12 as referenced in FIG. 1 tends to warp as it gets heated excessively. As shown, the workpiece 16 bends about a direction 52 once heating process is completed and upon release of any mechanical constraint. Depending on the degree of the constraints (bolting being the worst and suspending it in air being the best case) this residual stress in the 16 can translate to an unfavorable stress state within 42 or coating.

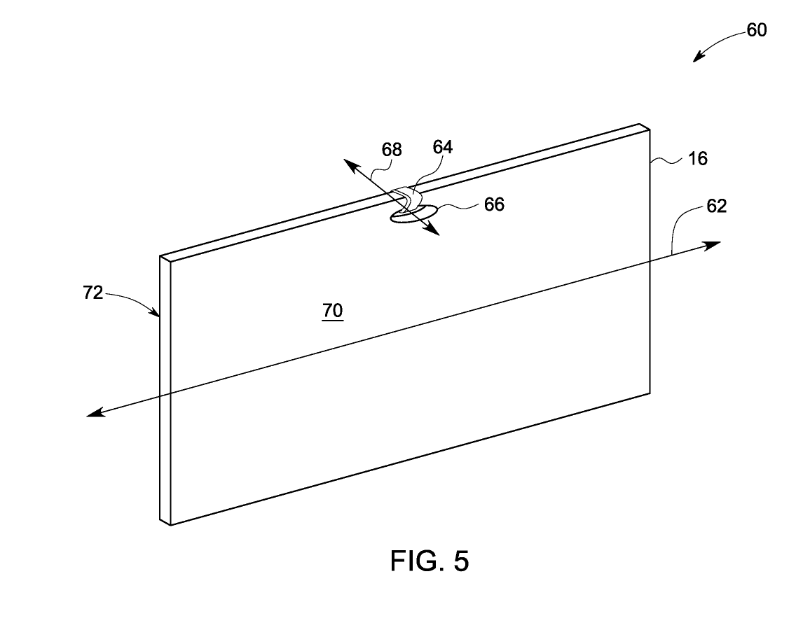

In an illustrated embodiment of the invention as shown in FIG. 5, a fixturing assembly 60 for a part of the workpiece 16 as referenced in FIG. 1 that is being sprayed is depicted. The fixturing assembly 60 tends to minimize residual stresses in the workpiece 16 leading to minimal warpage and coating stress. A spray gun 12 as referenced in FIG. 1 travels in a direction 62 in a plane of the workpiece 16 and sprays a front face 70 of the workpiece 16. The fixturing assembly 60 includes a clamp 64 fixed at a location 66 on the workpiece 16. The clamp 64 is necessary only to hold the work piece 16 in place and constrain it from moving in the out-of-plane direction 68. In order to prevent free expansion of the work piece to minimize residual stress build-up, the clamp 64 constrains the work piece only at location 66. The work piece 16 may be free without any constraint at other locations. During a process of thermal spraying, the workpiece 16 has more degrees of freedom to expand or contract thus resulting in lesser distortion upon cooling down to room temperature. In this embodiment, the clamp 64 at location 66 exerts minimal constraint on expansion or contraction of the workpiece 16 resulting in reduction in a build up of permanent strains and lower coating stresses built up on surface 70 once the process of thermal spraying is completed.

When a substantially planar component such as the workpiece 16 is thermally sprayed on the front face 70, temperature gradients develop through thickness of the workpiece 16 with a surface being sprayed such as the front face 70 being hotter than an opposite surface or a back face 72. Hence, the front face 70 has a tendency to expand relative to the back face 72 leading to a natural tendency for the workpiece 16 to curl out of plane in the direction 68. This leads to the front face 70 being convex. In a case where the workpiece 16 may be mechanically constrained at many locations to prevent the expansion, the front face 70 will get compressed further due to the natural constraint of a cooler underside. Consequently, the compression may lead to plastic yielding of the front face 70 thus building up a residual strain on the workpiece 16. Clamping the workpiece 16 at only one location 66 allows the workpiece 16 to curl out of plane relatively freely according to natural tendency due to differential heating of the front face 70 and the back face 72. This leads to minimal distortion of the workpiece 16 after the process of thermal spraying is completed. By relieving the compressive force or constraints on the front face 70 will also alleviate or reduce the tensile stresses developed in the coating.

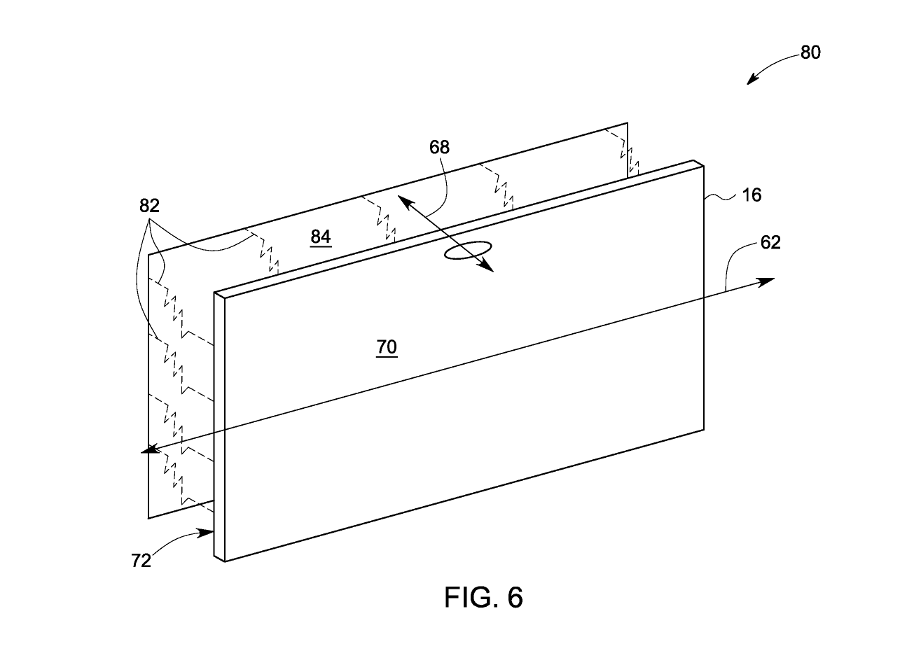

In another illustrated embodiment of the invention as shown in FIG. 6, a fixturing assembly 80 for a part of the workpiece 16 as referenced in FIG. 1 is depicted. A spray gun or assembly 12 as referenced in FIG. 1 sprays a front face 70 as referenced in FIG. 5 of part of the workpiece 16. The fixturing assembly 80 includes a bed or a foundation of independent springs 82 on a mounting plate 84 supporting a back face 72 as referenced in FIG. 5 of the workpiece 16 being sprayed in an out of plane direction 68 as referenced in FIG. 5. The independent springs 82 may include any material that may withstand operating temperature range resulting from exposure to the spray assembly 12. In a particular embodiment, the springs 82 may be shielded or insulated from direct heating of the thermal spray assembly 12. When the workpiece 16 is thermally sprayed on the front face 70, temperature gradients develop through the thickness of the workpiece 16. Thus, the front face 70 tends to get hotter than the back face 72 resulting in a natural tendency to expand relative to the back face 72. The front face 70 expands by becoming convex resulting in curling of the workpiece 16 in an out of plane direction 68 as referenced in FIG. 5. The bed of independent springs 82 supports the backface 72 such that it provides minimal constraint on the curling of the workpiece 16 in the out of plane direction 68. In addition, the flexibility of the springs 82 allows relatively free expansion or contraction and out-of-plane flexing of workpiece 16. This consequently reduces residual stress and build up of permanent strains leading to lesser distortions and coating stresses upon cool down and release of the workpiece 16 after the process of thermal spraying.

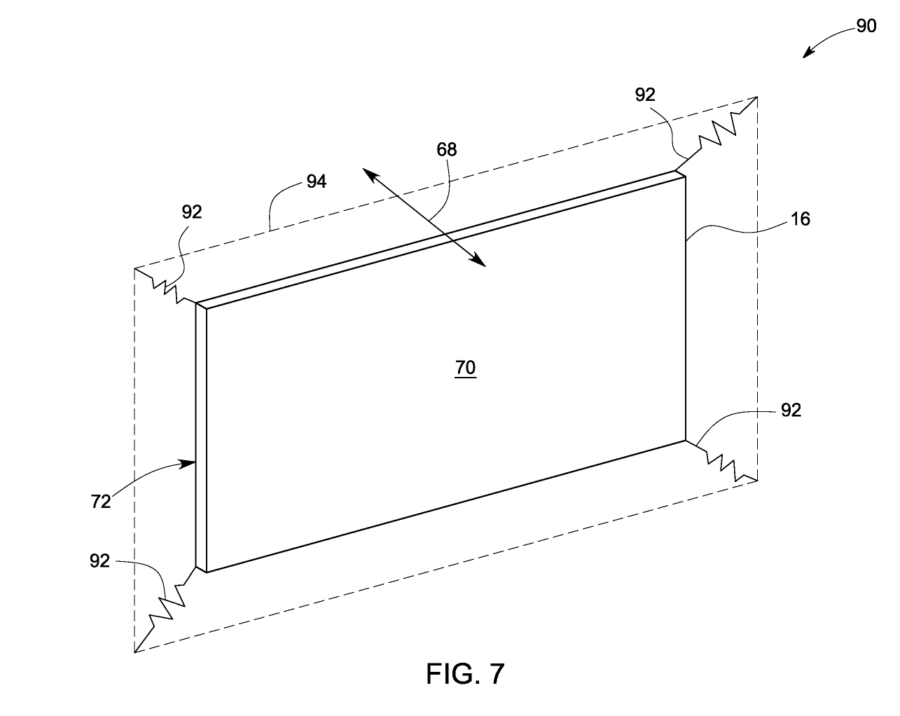

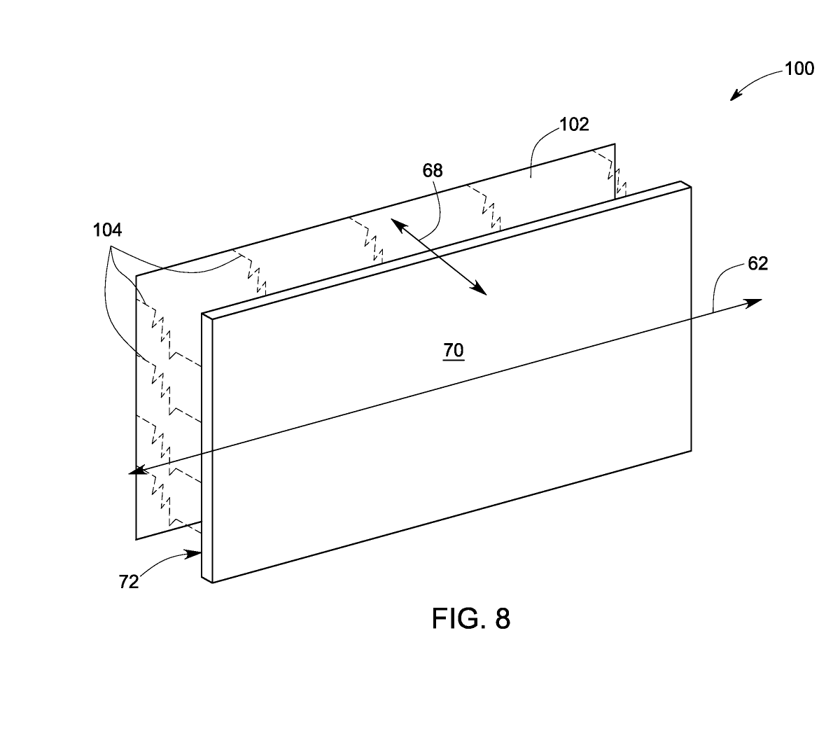

FIG. 7 is a diagrammatical illustration of another embodiment of a fixturing assembly 90 for a part of the workpiece 16 as referenced in FIG. 1. A spray gun 12 as referenced in FIG. 1 sprays a front face 70 as referenced in FIG. 5 of part of the workpiece 16. In the particular embodiment, the fixturing assembly 90 includes spring supports 92 tethered in-plane of the workpiece 16 at peripheral locations of the part of the workpiece 16 being sprayed. The spring supports 92 may be attached to a frame 94. During a thermal pray process, the front face 70 tends to become convex resulting in curling of the workpiece 16 in an out of plane direction 68 as referenced in FIG. 5. The spring supports 92 tethered in-plane provide limited out-of-plane stiffness leading to relatively free expansion and contraction of the part of the workpiece 16 in the out-of-plane direction 68 during a spray process. Further, the flexible nature of the spring supports 92 facilitates curling of the workpiece 16. This consequently reduces residual stress and build up of permanent strains leading to lesser distortions and lower coating stresses upon cool down and release of the workpiece 16 after the process of thermal spraying. In fact, this method can also act as a pre-tensioner to 16 and allow this elastic stress to be relieved upon cool down to further reduce coating stresses.

In another illustrated embodiment of the invention as shown in FIG. 8, a fixturing assembly 100 including a cushion of air 102 is depicted. A spray gun 12 as referenced in FIG. 1 travels in a direction 62 as referenced in FIG. 5 in plane of the workpiece 16 and sprays a front face 70 of the part of the workpiece 16. The cushion of air 102 supports a backface 72 as referenced in FIG. 5 of the part of the workpiece 16 so that the part can bend freely in an out-of-plane direction 68 as referenced in FIG. 5 without any build up of strain. The cushion of air 102 serves a purpose of a solid wall without mechanical stiffness. In a particular embodiment, the fixturing assembly 100 may also include a foam backing material. Lines 104 indicate a spring like quality of the fixturing assembly introduced in this embodiment. During a thermal spray process, the front face 70 tends to become convex due to a temperature differential between the front face 70 and the back face 72. This results in a natural tendency of curling of the workpiece 16 in the out-of-plane direction 68. The cushion of air 102 facilitates in such a movement due to spring like quality in it. Consequently, this reduces residual stress and build up of permanent strains leading to lesser distortions and coating stresses upon cool down and release of the workpiece 16 after the process of thermal spraying.

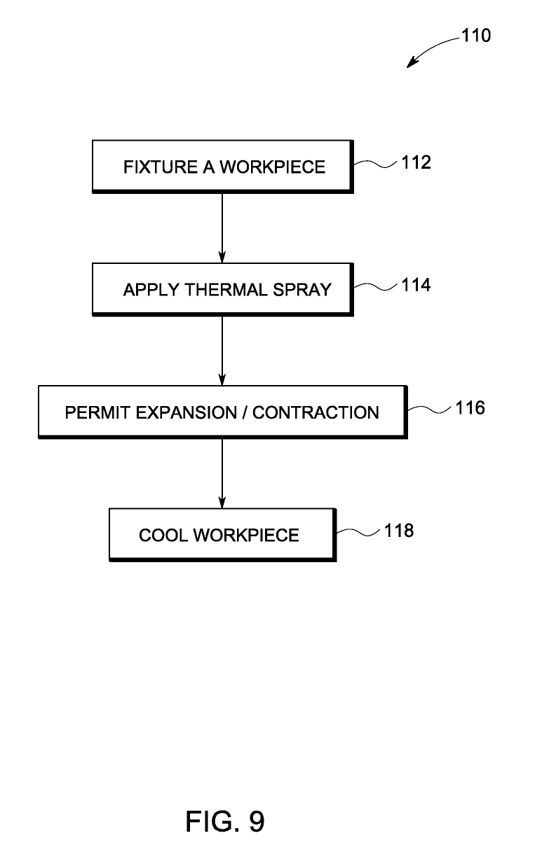

FIG. 9 is a flow chart representing exemplary steps in a method 110 of thermal spraying a workpiece 16 as referenced in FIG. 1. The method 110 includes fixturing the workpiece in step 112. In one embodiment, the fixturing may include clamping at least one location of the workpiece. In another embodiment, the fixturing may include coupling series of springs to the workpiece. In another embodiment, the fixturing may include tethering spring supports to said workpiece. In another particular embodiment, the fixturing may include providing a cushion of air or a foam of backing material to the workpiece. Once the fixturing has taken place, a thermal spray is applied on the workpiece in step 114. During the thermal spray process, a portion of the workpiece directly under the spray heats up consequently tending to expand or contract. To minimize residual stress in the component and coating stress, the method 110 also includes allowing the workpiece to expand or contract with minimal interference from the fixturing in step 116. Once the workpiece expands or contracts freely, the method 100 further includes cooling the workpiece in step 118 to allow the workpiece to recover from a warped position.

### EXAMPLES

The examples that follow are merely illustrative, and should not be construed to be any sort of limitation on the scope of the claimed invention.

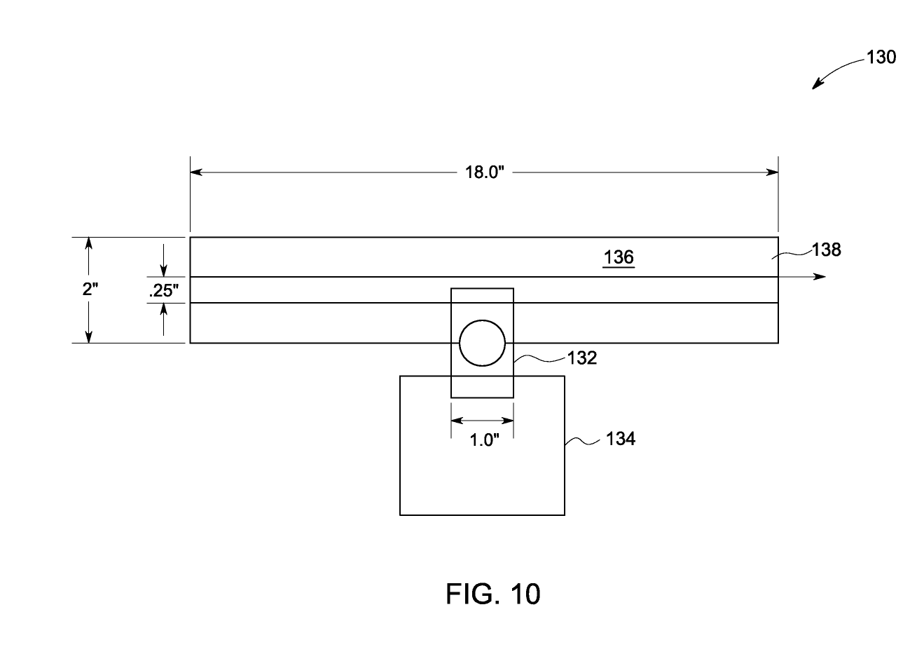

A series of experiments using strips of stainless steel as a sample were performed to detect warpage in a hydrogen electrolyzer electrode. The strips of stainless steel were thermally sprayed using wire-arc spraying technique. Measurements were made on strips of varying thicknesses that had a supported or an unsupported backface. FIG. 10 is a diagrammatic illustration of an experimental set up of a strip of stainless steel with a fixturing assembly 130. The fixturing assembly 130 included a clamp 132 to a backing plate 134 on a location at the backface 136 of a stainless steel strip 138 being sprayed. The backing plate 134 prevented backward curl of the sample during spraying process. Length of the sample was about 18 inches and breadth of the strip was about 2 inches. Varying thicknesses of the sample were 0.032 inch, 0.062 inch and 0.125 inch. The speeds of the spray gun used were 700 mm/sec and 1100 mm/sec. The spray gun was placed at a distance of about 3 inches from the sample and length of a spray window was about 26 inches.

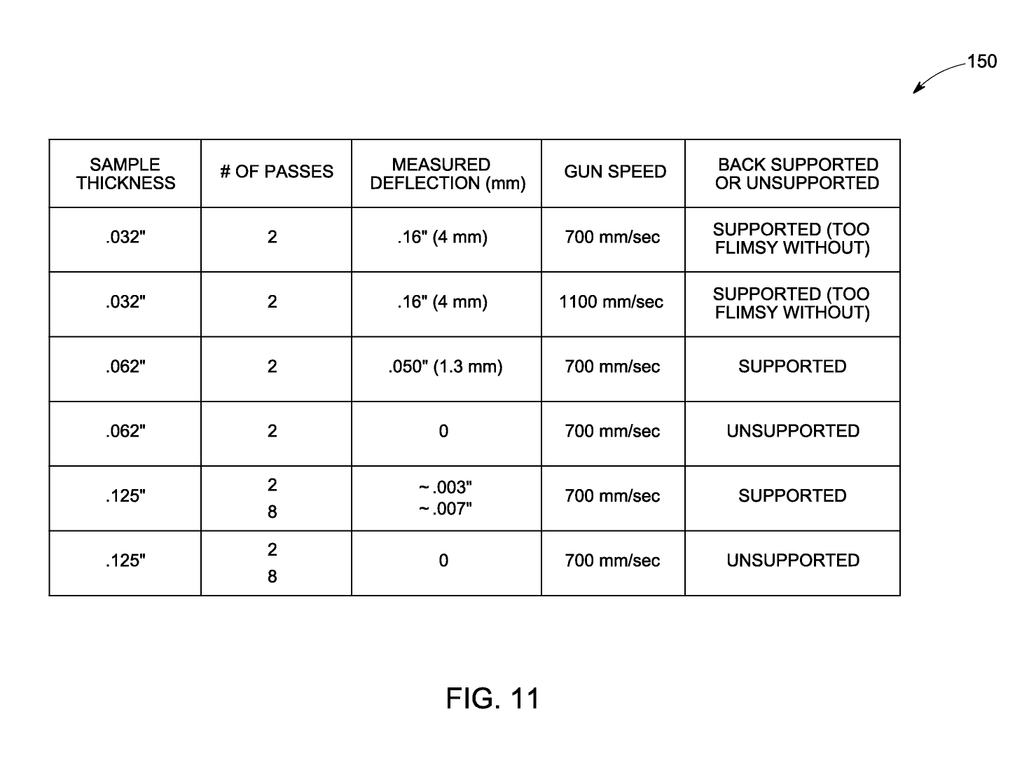

FIG. 11 is a tabular representation 150 of the results of the measurements made on the sample at varying thicknesses and with a supported and an unsupported backface. The measurements include measuring deflections or warpage in the sample during the thermal spraying process. As seen from the table, samples with an unsupported backface show no deflection or warpage while the samples with a supported backface indicate a small amount of deflection. In addition, samples of thickness 0.032 inch and a supported backface showed no change in measure of deflection with increase in speed of the spray gun. Hence, the results indicate that an unsupported backface that allows for free movement of a part of the workpiece during spraying process leads to no residual stresses or warpage of the workpiece. Further, warping of a sample is independent of the spray gun speed.

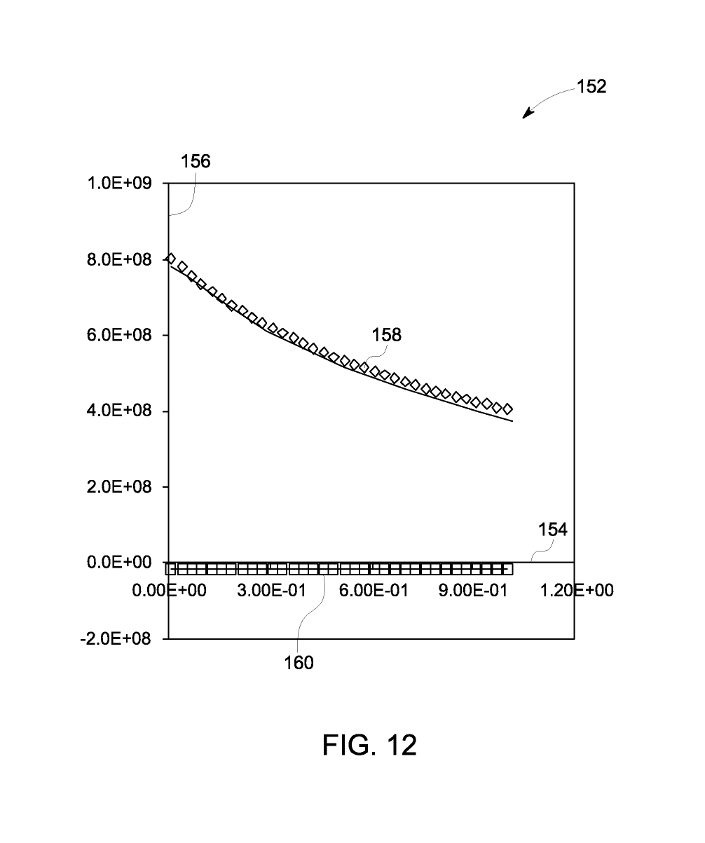

FIG. 12 is a graphical comparison 152 of stresses induced in a coating deposited on a mechanically constrained substrate, also referred to as ‘constrained sample’ versus stresses induced in a coating deposited on a mechanically unconstrained substrate, also referred to as ‘unconstrained sample’, as a function of the coating thickness. X-axis 154 represents ratio of coating thickness to substrate thickness. Y-axis 156 represents stress due to coating and is measured in N/m² units. Curve 158 represents the stress in a constrained sample while curve 160 represents stress in an unconstrained sample. As seen, there is a significant difference in stress levels in a sample that is constrained as compared to a sample that is unconstrained. There are high levels of coating stress in a constrained sample and much lower levels of coating stress in an unconstrained sample.

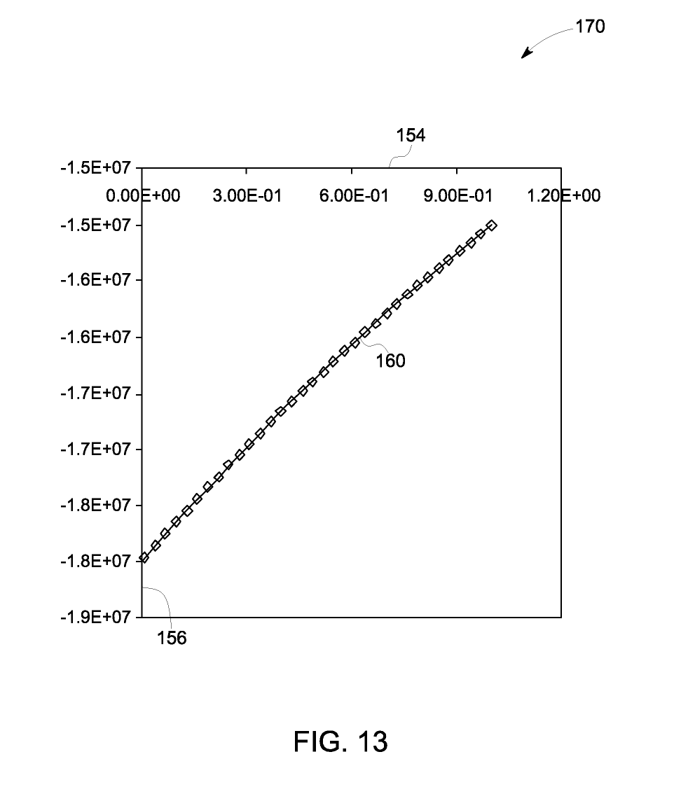

FIG. 13 is a magnified version 170 of the curve 160 in FIG. 12. Curve 160 seems to be a straight line in FIG. 12 due to a large difference in stress levels in a constrained sample as compared to an unconstrained sample. As seen in FIG. 13, curve 160 is relatively sensitive to the thickness of coating and there seem to be compressive stresses, as indicated by negative values, associated with a sample under no constraints during a thermal spraying process.

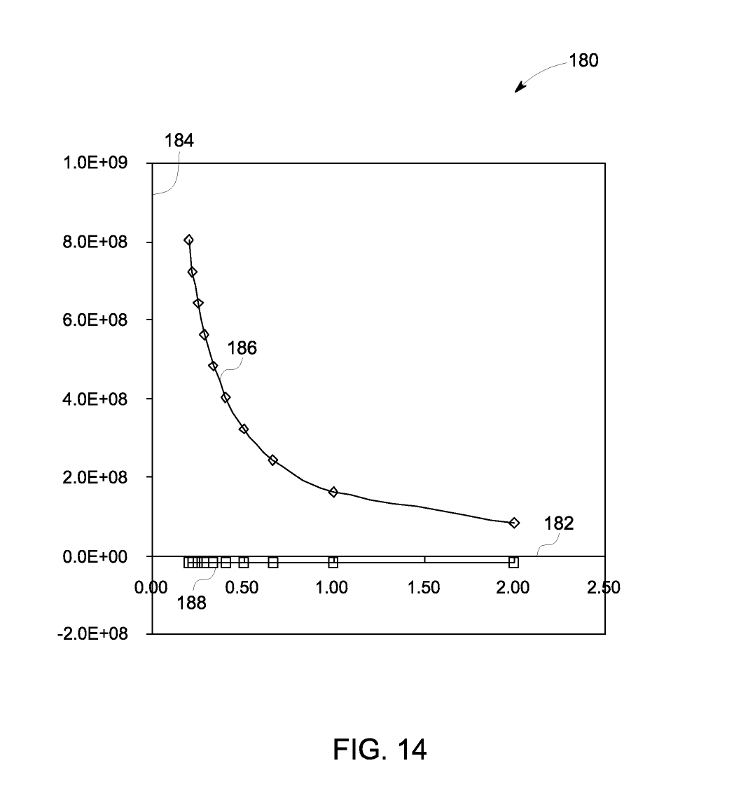

FIG. 14 is a graphical comparison 180 of coating stress on a sample under constraints versus an unconstrained sample as a function of coating modulus. X-axis 182 represents ratio of coating modulus to substrate modulus. Y-axis 184 represents stress due to coating and is measured in N/m² units. Curve 186 represents the stress in a constrained sample while curve 188 represents stress in an unconstrained sample. As seen by comparison of the two curves 186 and 188, there is a significant difference in stress levels in a sample that is constrained as compared to a sample that is unconstrained. There are high levels of coating stress in a constrained sample and much lower levels of coating stress in an unconstrained sample.

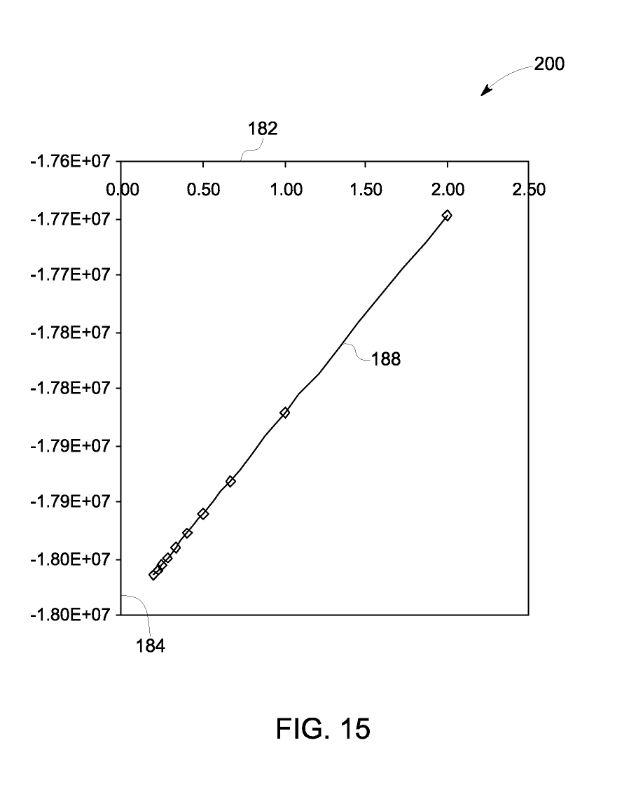

FIG. 15 is a magnified view 200 of the curve 188 in FIG. 14 drawn to an expanded scale. Curve 188 seems to be a straight line in FIG. 14 due to a large difference in stress levels in a constrained sample as compared to an unconstrained sample. As seen, curve 188 has limited sensitivity to the coating modulus and there seem to be compressive stresses associated with a sample of specific thickness and moduli system, as indicated by negative values, under no constraints during a thermal spraying process.

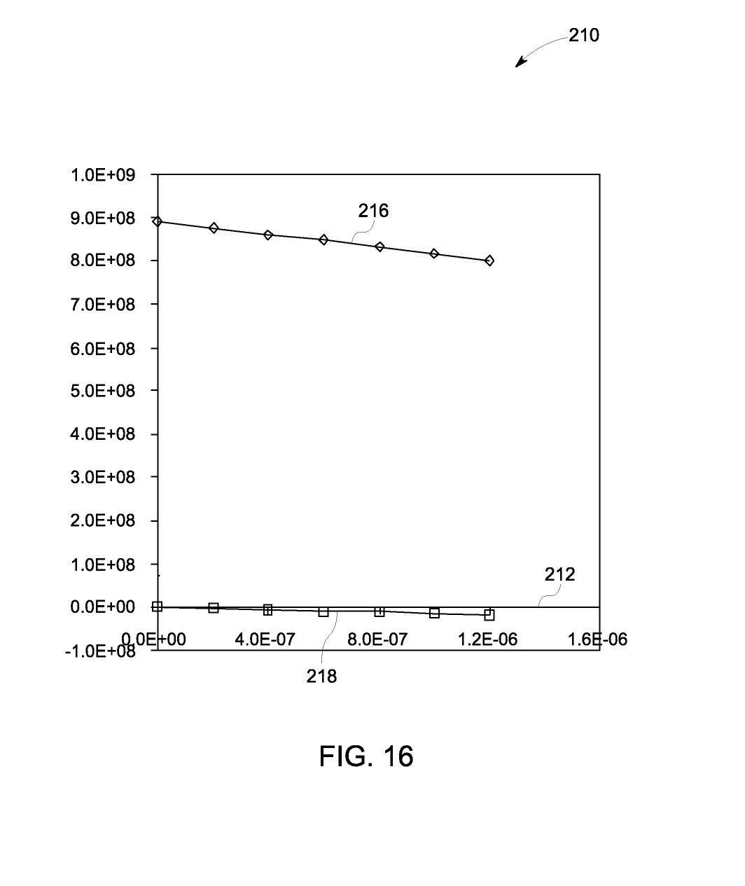

FIG. 16 is a graphical comparison 210 of coating stress on a sample under constraints versus an unconstrained sample as a function of thickness of coating. X-axis 212 represents difference of coefficient of thermal expansion (CTE) between coating and the substrate. Y-axis 214 represents stress due to coating and is measured in N/m² units. Curve 216 represents the stress in a constrained sample while curve 218 represents stress in an unconstrained sample. As seen, there is a significant difference in stress levels in a sample that is constrained as compared to a sample that is unconstrained. There are high levels of coating stress in a constrained sample and much lower levels of coating stress in an unconstrained sample.

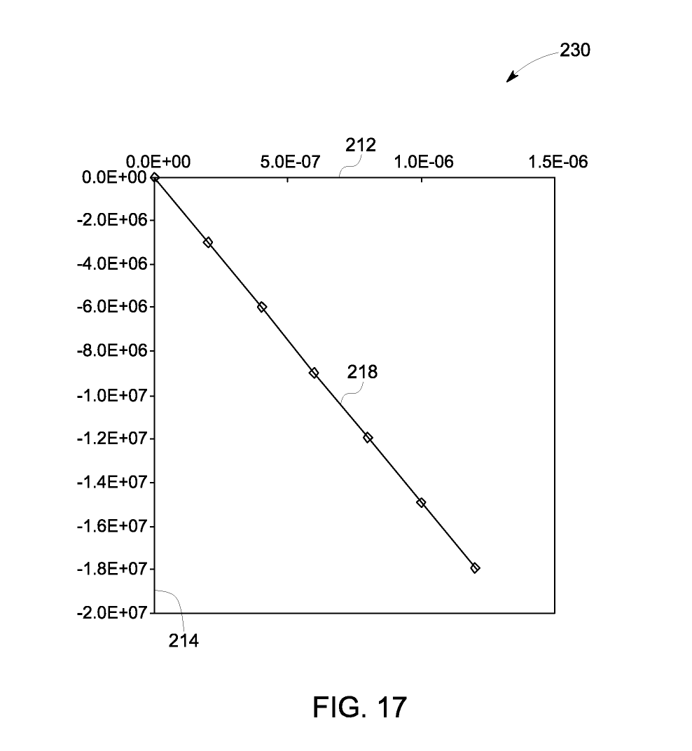

FIG. 17 is a magnified version 230 of the curve 218 in FIG. 16 drawn to an expanded scale. Curve 218 seems to be a straight line in FIG. 12 due to a large difference in stress levels in a constrained sample as compared to an unconstrained sample. As seen, curve 218 is very sensitive to the thickness of coating and there seem to be compressive stresses associated with a sample, as indicated by negative values, under no constraints.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A thermal spray system comprising:
a spray assembly for applying a coating to a workpiece; and
a fixturing assembly couplable to said workpiece for positioning said workpiece relative to said thermal spray system; wherein said fixturing assembly permits said workpiece to deform during application of said coating to minimize residual strain buildup within said workpiece and minimize coating stress upon cool down.

2. A thermal spray system in accordance with claim 1, wherein said thermal spray system is selected from the group consisting of DC plasma spray, wire-arc spray, flame spray, or high-velocity oxygen fuel thermal spray process (HVOF).

3. A thermal spray system in accordance with claim 1, wherein said workpiece is selected from the group of a fuel cell component, an electrolyzer component, a hot gas path component, a compressor, a pump component and an electronic device.

4. A thermal spray system in accordance with claim 1, wherein said workpiece is a solid oxide fuel cell component.

5. A thermal spray system in accordance with claim 1, wherein said workpiece is an alkaline electrolyzer component.

6. A thermal spray system in accordance with claim 1, wherein said fixturing assembly comprises of one clamp couplable at a single location on said workpiece.

7. A thermal spray system in accordance with claim 1, wherein said fixturing assembly comprises of a plurality of clamps attached to the workpiece at locations so as to minimize mechanical constraints to free expansion of the workpiece at coating temperatures.

8. A thermal spray system in accordance with claim 1, wherein said fixturing assembly comprises a series of springs coupled to said workpiece.

9. A thermal spray system in accordance with claim 1, wherein said fixturing assembly comprises a plurality of tethers coupled to said workpiece.

10. A thermal spray system in accordance with claim 1, wherein said fixturing assembly comprises an air cushion.

11. A thermal spray system in accordance with claim 1, wherein said fixturing assembly comprises a foam backing material.

12. A thermal spray system in accordance with claim 1, wherein the operating temperature of the thermal spray is in the range between about 800° C. to about 7000° C.

13. A thermal spray apparatus comprising:
a fixturing device configured to physically hold a part over an unsprayed surface while permitting a sprayed and unsprayed part to distort during application of a thermal spray.

14. A method of thermal spraying comprising the method steps of:
fixturing a workpiece;
applying a thermal spray to said workpiece;
allowing said workpiece to expand or contract due to the application of said thermal spray with minimal interference from said fixturing; and
cooling said workpiece to allow said workpiece to recover from during spray expansion or contraction.

15. The method of claim 14, wherein fixturing comprises clamping one location of said workpiece or along one line of symmetry of said workpiece.

16. The method of claim 14, wherein fixturing comprises clamping a plurality of clamps strategically located so as to minimize accumulated residual strains.

17. The method of claim 14, wherein fixturing comprises coupling series of springs to said workpiece.

18. The method of claim 14, wherein fixturing comprises tethering spring supports to said workpiece.

19. The method of claim 14, wherein fixturing comprises providing a cushion of air.

20. The method of claim 14, wherein fixturing comprises providing a foam backing material.
